(19) United States
(12) Patent Application Publication
(10) Pub. No.: US 2025/0362396 A1
(43) Pub. Date: Nov. 27, 2025

(54) PHOTONIC INTEGRATED CIRCUIT AND INSPECTION METHOD THEREOF

(71) Applicant: DELTA ELECTRONICS, INC., Taoyuan City (TW)

(72) Inventors: Teng-Hsiang CHANG, Taoyuan City (TW); En-Hung LIN, Taoyuan City (TW); He ZHANG, Taoyuan City (TW); Dongdong LI, Singapore (SG); Jack Sheng KEE, Singapore (SG)

(21) Appl. No.: 18/762,998

(22) Filed: Jul. 3, 2024

(30) Foreign Application Priority Data
May 27, 2024 (CN) 2024106626807

(51) Int. Cl. G01S 7/497; G01S 7/481; G01S 7/4911; G01S 17/89

(52) U.S. Cl. CPC G01S 7/497; G01S 7/4814; G01S 7/4911; G01S 17/89

(57) ABSTRACT

An inspection method of a photonic integrated circuit, the inspection method includes steps of: generating a main laser light; splitting the main laser light into a detection laser light and a reference laser light; splitting the reference laser light into a first laser light and a second laser light; splitting the first laser light into a first sub-laser light and a second sub-laser light; modulating a frequency of the first sub-laser light; coupling the first sub-laser light being modulated and the second sub-laser light to generate a first coupling light; inspecting an interference spectrum of the first coupling light; and adjusting a power or a linewidth of the main laser light according to the interference spectrum. The disclosure also discloses a photonic integrated circuit.

### BACKGROUND OF THE DISCLOSURE

### Technical Field

The present disclosure relates to an integrated circuit, particularly relates to a photonic integrated circuit and an inspection method thereof.

### Description of Related Art

In the application such as autonomous vehicle, unmanned aerial vehicle, or industrial robot, etc., laser is used to perform imaging or sensing as the foundation of analyzing and understanding three dimensional (3D) environment. In the moving environment, understanding 3D environment needs to precisely and reliably categorize objects, track current positions of the objects, and predict next move of the objects. For example, in the application of autonomous vehicle, the system may need to identify and track many objects in real-time, and LiDAR is usually used to achieve laser imaging, detection, and range-finding.

Therefore, in the application of detection, range-finding, etc., 3D image with high depth, high precision, and high resolution is desired. In other words, the intensity, line width, and linearity of the laser light may influence the capability of detection and range-finding of the photonic integrated circuit applied in the LiDAR.

### SUMMARY OF THE DISCLOSURE

The disclosure provides a photonic integrated circuit and an inspection method thereof, which may inspect the intensity, line width, and linearity of the laser light.

The disclosure provides an inspection method of a photonic integrated circuit, the inspection method including steps of: generating a main laser light; splitting the main laser light into a detection laser light and a reference laser light; splitting the reference laser light into a first laser light and a second laser light; splitting the first laser light into a first sub-laser light and a second sub-laser light; modulating a frequency of the first sub-laser light; coupling the first sub-laser light being modulated and the second sub-laser light to generate a first coupling light; inspecting an interference frequency spectrum of the first coupling light; and adjusting a power or a line width of the main laser light according to the interference frequency spectrum.

In some embodiments, the inspecting of the interference frequency spectrum of the first coupling light further includes steps of: calculating a light intensity of the first coupling light according to the interference frequency spectrum; and determining whether the light intensity is in a pre-determined range.

In some embodiments, the adjusting of the power or the line width of the main laser light according to the interference frequency spectrum further includes a step of: adjusting the power of the main laser light, if the light intensity is determined to be outside the pre-determined range.

In some embodiments, the inspecting of the interference frequency spectrum of the first coupling light further includes a step of: calculating a full width at half maximum (FWHM) of the first coupling light according to the interference frequency spectrum; and determining whether the FWHM is greater than or equal to a pre-determined value.

In some embodiments, the adjusting of the power or the line width of the main laser light according to the interference frequency spectrum further includes a step of: adjusting the line width of the main laser light, if the FWHM is determined to be greater than or equal to the pre-determined value.

In some embodiments, the inspection method of the photonic integrated circuit further includes steps of: forming a time difference between the first sub-laser light and the second sub-laser light; coupling the first sub-laser light and the second sub-laser light to generate a second coupling light; calculating a signal frequency spectrum of the second coupling light according to the time difference; restoring the main laser light according to the signal frequency spectrum; and determining whether the main laser light is consistent with a pre-determined linearity.

In some embodiments, the determining of whether the main laser light is consistent with a pre-determined linearity further includes a step of: adjusting a linearity of the main laser light, if the main laser light is determined to be non-consistent with the pre-determined linearity.

The disclosure also provides an inspection method of a photonic integrated circuit, the inspection method including steps of: generating a main laser light; splitting the main laser light into a detection laser light and a reference laser light; splitting the reference laser light into a first laser light and a second laser light; splitting the first laser light into a first sub-laser light and a second sub-laser light; providing a radio frequency signal to the first sub-laser light; coupling the first sub-laser light being modulated and the second sub-laser light to generate a first coupling light; inspecting an interference frequency spectrum of the first coupling light; and adjusting a power or a line width of the main laser light according to the interference frequency spectrum.

The disclosure also provides a photonic integrated circuit including: a laser light source, configured to generate a main laser light; a first splitter, configured to receive the main laser light, and to split the main laser light into a detection laser light and a reference laser light; a second splitter, configured to receive the reference laser light, and to split the reference laser light into a first laser light and a second laser light; and an inspection unit, configured to receive the first laser light, and including: a third splitter, configured to receive the first laser light, and to split the first laser light into a first sub-laser light and a second sub-laser light; a modulating element, configured to receive the first sub-laser light, and to modulate a frequency of the first sub-laser light; a light-coupling element, configured to receive and couple the second sub-laser light and the first sub-laser light being modulated, and to generate a first coupling light; and a processing element, configured to inspect an interference frequency spectrum of the first coupling light. The inspection unit is configured to adjust a power or a line width of the main laser light according to the interference frequency spectrum.

In some embodiments, the processing element is configured to calculate a light intensity of the first coupling light according to the interference frequency spectrum and determine whether the light intensity is in a pre-determined range. The processing element is configured to adjust the power of the main laser light, if the light intensity is determined to be outside the pre-determined range.

In some embodiments, the processing element is configured to calculate a full width at half maximum (FWHM) of the first coupling light according to the interference frequency spectrum and determine whether the FWHM is greater than or equal to a pre-determined value. The processing element is configured to adjust the line width of the main laser light, if the FWHM is determined to be greater than or equal to the pre-determined value.

In some embodiments, the modulating element is configured to receive a radio frequency signal, and to modulate the frequency of the first sub-laser light according to the radio frequency signal.

In some embodiments, the inspection unit further includes a delay element, configured to receive the first sub-laser light and form a time difference between the first sub-laser light and the second sub-laser light. The light-coupling element is configured to couple the first sub-laser light and the second sub-laser light to generate a second coupling light.

In some embodiments, the processing element is configured to calculate a signal frequency spectrum of the second coupling light according to the time difference and restore the main laser light according to the signal frequency spectrum. The processing element is configured to adjust a linearity of the main laser light, if the main laser light is determined to be non-consistent with a pre-determined linearity.

In summary, the photonic integrated circuit and the inspection method thereof in the disclosure is using the inspection unit to inspect the reference laser light. For example, after the reference laser light is split, the frequency of one laser light is being modulated, and the modulated laser light (for example, the first sub-laser light) and the unmodulated laser light (for example, the second sub-laser light) are being coupled. Afterward, the interference frequency spectrum of the coupling light may be inspected to obtain the parameters, such as the light intensity and full width at half maximum (FWHM), etc. The light intensity is proportional to the power, thus whether the power of the laser light source is consistent with the required value may be determined by determining whether the light intensity is in the pre-determined range, and the power of the laser light source may be adjusted accordingly. Similarly, the FWHM is proportional to the line width, thus whether the line width of the laser light source is consistent with the required value may be determined by determining whether the FWHM is greater than or equal to the pre-determined value, and the line width of the laser light source may be adjusted accordingly. Further, after the reference laser light is split, the laser light may not be modulated, and the time difference may be formed between two laser light by using optical path difference. The signal frequency spectrum of the coupling light is calculated based on the time difference. As a result, whether the linearity of the laser light source is consistent with the required value may be determined by restoring the signal frequency spectrum to the waveform of the main laser light. Therefore, the photonic integrated circuit and the inspection method thereof in the disclosure may be used to confirm whether the power, line width, and linearity of the main laser light generated by the laser light source is consistent with requirement.

### BRIEF DESCRIPTION OF THE DRAWINGS

FIG. 1 is a block diagram of the photonic integrated circuit in one embodiment of the disclosure.

FIG. 2 is a block diagram of the inspection unit of the photonic integrated circuit in the embodiment of the disclosure.

FIG. 3 is a flowchart of the inspection method of the photonic integrated circuit in the first embodiment of the disclosure.

FIG. 4 is a schematic diagram of voltage-time of the first coupling light in the embodiment of the disclosure.

FIG. 5 is a schematic diagram of interference frequency spectrum of the first coupling light in the embodiment of the disclosure.

FIG. 6 is a flowchart of the inspection method of the photonic integrated circuit in the second embodiment of the disclosure.

FIG. 7 is a curve chart of the relation between the light intensity of the first coupling light and the laser power.

FIG. 8A is a curve chart of the relation between the light intensity of the first coupling light and the frequency.

FIG. 8B is a curve chart of the relation between the FWHM of the first coupling light and the line width of the laser light.

FIG. 9 is a curve chart of the relation between the noise level of the first coupling light and the line width of the laser light.

FIG. 10A and FIG. 10B are a flowchart of the inspection method of the photonic integrated circuit in the third embodiment of the disclosure.

FIG. 11A is a schematic diagram of the first sub-laser light and the second sub-laser light before the time difference is formed.

FIG. 11B is a schematic diagram of the first sub-laser light and the second sub-laser light after the time difference is formed.

FIG. 11C is a schematic diagram of voltage-time of the second coupling light in the embodiment of the disclosure.

FIG. 11D is a schematic diagram of the main laser light which is restored according to the signal frequency spectrum.

FIG. 12A and FIG. 12B are a flowchart of the inspection method of the photonic integrated circuit in the fourth embodiment of the disclosure.

FIG. 13 is a flowchart of the inspection method of the photonic integrated circuit in the fifth embodiment of the disclosure.

### DETAILED DESCRIPTION

As used in the present disclosure, terms such as “first”, “second” are employed to describe various elements, components, regions, layers, and/or parts. These terms should not be construed as limitations on the mentioned elements, components, regions, layers, and/or parts. Instead, they are used merely for distinguishing one element, component, region, layer, or part from another. Unless explicitly indicated in the context, the usage of terms such as “first”, “second” does not imply any specific sequence or order.

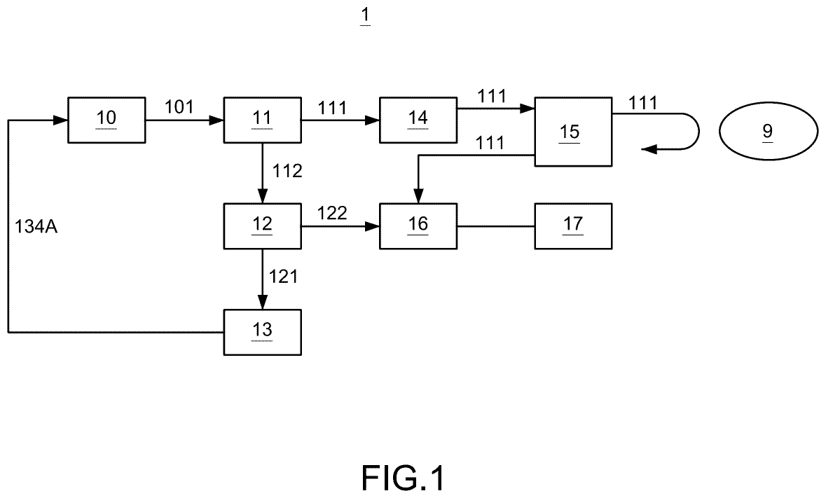

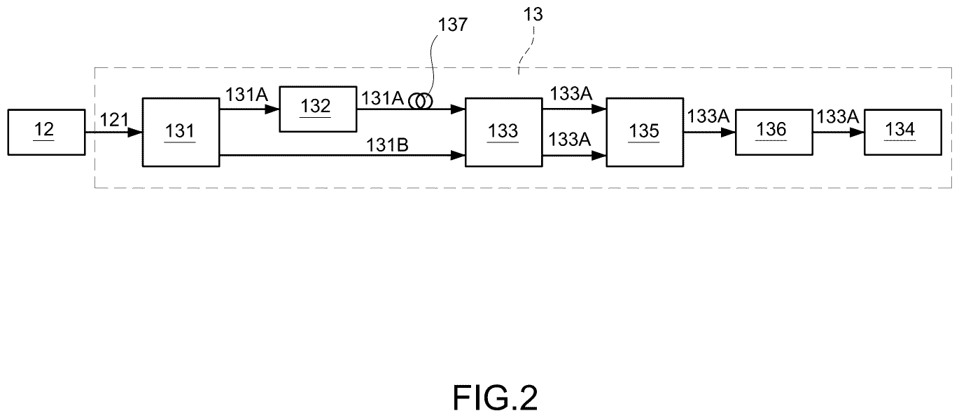

FIG. 1 is a block diagram of the photonic integrated circuit 1 in one embodiment of the disclosure. FIG. 2 is a block diagram of the inspection unit 13 of the photonic integrated circuit 1 in the embodiment. As shown in FIG. 1, in some embodiments, the photonic integrated circuit 1 includes, for example, a laser light source 10, a first splitter 11, a second splitter 12, and an inspection unit 13. The laser light source 10 may generate a main laser light 101. The laser light source 10 includes, for example, a silicon photonics chip, which may provide rapid wavelength tuning and/or well-behaved frequency sweeps (that is, chirping), and generate the main laser light 101 of frequency modulated continuous wave (FMCW).

The first splitter 11 may be, for example, an optical splitter, which receives the main laser light 101 and splits the main laser light 101 into a detection laser light 111 and a reference laser light 112. The detection laser light 111 is used for emitting to the object 9 to be detected, and reflecting back to the photonic integrated circuit 1 to perform imaging with the distance information from the interference of the returned detection laser light 11 and the original reference laser light 112. The second splitter 12 may be an optical splitter the same as or different from the first splitter 11. The second splitter 12 receives the reference laser light 112, and splits the reference laser light 112 into a first laser light 121 and a second laser light 122. The first laser light 121 is used for inputting to the inspection unit 13 for inspection. The second laser light 122 is used as the split light of the original reference laser light 112 for the interference with the returned detection laser light 111 to perform imaging.

It is worth mentioning that, in some embodiments, the photonic integrated circuit 1 may further include an amplifier 14, an input/output unit 15, a mixing unit 16, and a backend processing unit 17, here is not intended to be limiting. The amplifier 14, for example, receives the detection laser light 111, and is used to amplify the signal of the detection laser light 111. The input/output unit (for example, a scanner) 15 may receive the amplified detection laser light 111, emit the detection laser light 111 to the object 9 to be detected, and receive the reflected detection laser light 111 from the object 9 to be detected. The mixing unit 16 receives the reflected detection laser light 111 and the second laser light 122 (the split light of the original reference laser light 112), and couples two lights to transmit to the backend processing unit 17 for detection and imaging, etc. The backend processing unit 17 may be, for example, structured by the circuit elements, such as detector, amplifier, and analog-to-digital converter (ADC), here is not intended to be limiting. The backend processing unit 17 is used to perform detection and imaging. It should be noted that the photonic integrated circuit 1 may have or not have the amplifier 14, input/output unit 15, mixing unit 16, and/or backend processing unit 17, or may have the other similar or related circuit elements.

As shown in FIG. 2, in some embodiments, the inspection unit 13 includes a third splitter 131, a modulating element 132, a coupling element 133, and a processing element 134. The third splitter 131 may be an optical splitter the same as or different from the first splitter 11 and the second splitter 12. The third splitter 131 receives the first laser light 121, and splits the first laser light 121 into a first sub-laser light 131A and a second sub-laser light 131B. The first sub-laser light 131A is used to be modulated or form a time difference by an optical path difference for the interference with the second sub-laser light 131B to perform inspection.

The modulating element 132 may be, for example, an optical modulator. The modulating element 132 receives the first sub-laser light 131A. In some embodiments, the modulating element 132 may modulates the frequency of the first sub-laser light 131A. The coupling element 133 may receive the second sub-laser light 131B and the first sub-laser light 131A being modulated, and couple the second sub-laser light 131B and the first sub-laser light 131A being modulated to generate a first coupling light 133A. The processing element 134 may include, for example, a central processing unit (CPU), or a programmable logic device (PLD), which may change the circuit structure after being manufactured, such as a field-programmable gate array (FPGA), or a specific design circuit used for performing specific processing, such as having an application specific integrated circuit (ASIC), etc., here is not intended to be limiting. The processing element 134 may inspect the interference frequency spectrum of the first coupling light 133A. In some embodiments, the processing element 134 may adjust the power or line width of the main laser light 101 according to the interference frequency spectrum.

It is worth mentioning that, in some embodiments, the inspection unit 13 may include a Balanced Photodetector (BPD) 135 and a transimpedance amplifier (TIA) 136, here is not intended to be limiting. The BPD 135 is electrically connected with the coupling element 133, and used to lower the noise in the first coupling light 133A generated by the coupling element 133. The TIA 136 is electrically connected with the BPD 135 and the processing element 134, amplifies the optical signal of the first coupling light 133A, that the noise is lowered by the BPD 135, and outputs the amplified optical signal to the processing element 134. It should be noted that the inspection unit 13 may have or not have the BPD 135 and/or TIA 136, or may have the other similar or related circuit elements.

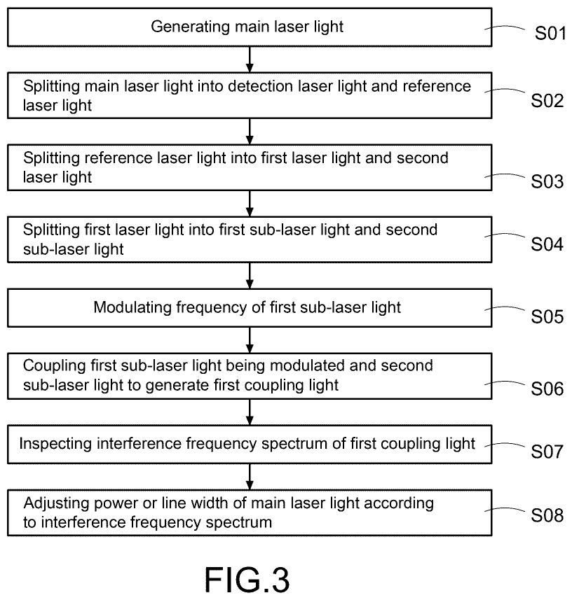

FIG. 3 is a flowchart of the inspection method of the photonic integrated circuit in the first embodiment of the disclosure. As shown in FIG. 3, the inspection method of the embodiment includes the step S01 to the step S08. The step S01 is generating the main laser light. The step S02 is splitting the main laser light into the detection laser light and the reference laser light. The step S03 is splitting the reference laser light into the first laser light and the second laser light. The step S04 is splitting the first laser light into the first sub-laser light and the second sub-laser light. The step S05 is modulating the frequency of the first sub-laser light. The step S06 is coupling the modulated first sub-laser light and the second sub-laser light to generate the first coupling light. The step S07 is inspecting the interference frequency spectrum of the first coupling light. The step S08 is adjusting the power or the line width of the main laser light according to the interference frequency spectrum.

The inspection method of the photonic integrated circuit 1 in the first embodiment is described with reference to FIG. 1, FIG. 2, and FIG. 3. In the step S01, the laser light source may generate the main laser light 101. In the step S02, the first splitter 11 may receive the main laser light 101, and split the main laser light 101 into the detection laser light 111 and the reference laser light 112. In the step S03, the second splitter 12 may receive the reference laser light 112, and split the reference laser light 112 into the first laser light 121 and the second laser light 122. In the step S04, the third splitter 131 of the inspection unit 13 may receive the first laser light 131, and split the first laser light 121 into the first sub-laser light 131A and the second sub-laser light 131B.

In the step S05, the modulating element 132 of the inspection unit 13 may receive the first sub-laser light 131A, and modulate the frequency of the first sub-laser light 131A. In some embodiments, the modulating element 132, for example, may receive a radio frequency (RF) signal (not shown in figures), and provide the RF signal to the first sub-laser light 131A to modulate the frequency of the first sub-laser light 131A, here is not intended to be limiting. In the step S06, the coupling element 133 of the inspection unit 13 may receive the second sub-laser light 131B and the modulated first sub-laser light 131A, and couple the second sub-laser light 131B and the modulated first sub-laser light 131A to generate the first coupling light 133A.

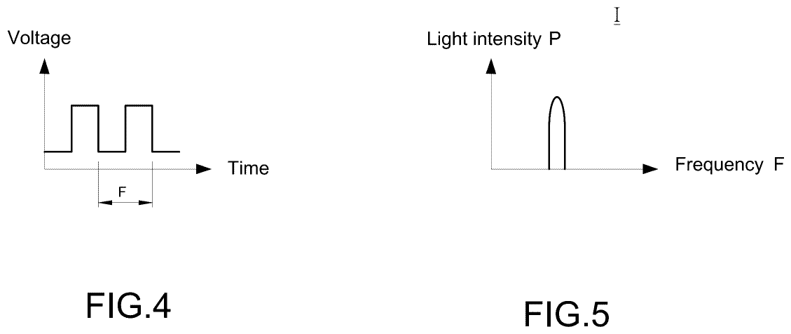

FIG. 4 is a schematic diagram of voltage-time of the first coupling light in the embodiment. As shown in FIG. 2, FIG. 3, and FIG. 4, the coupling element 133 couples the second sub-laser light 131B and the modulated first sub-laser light 131A to generate the first coupling light 133A. The first coupling light 133A is, for example, a beat frequency signal. The frequency F of the first coupling light 133A is related to the frequency of the modulated first sub-laser light 131A. Referring back to FIG. 1, FIG. 2, and FIG. 3, in the step S07, the processing element 134 of the inspection unit 13 may inspect the interference frequency spectrum of the first coupling light 133A. In the step S08, the processing element 134 of the inspection unit 13 may adjust the power or the line width of the main laser light 101 according to the interference frequency spectrum.

FIG. 5 is a schematic diagram of interference frequency spectrum of the first coupling light in the embodiment. As shown in FIG. 3 and FIG. 5, the distribution of the interference frequency spectrum I of the first coupling light 133A may be obtained by using fast Fourier transform to the beat frequency signal of the first coupling light 133A. Further, the processing element 134 of the inspection unit 13 may inspect the power of the main laser light 101 according to the light intensity P in the interference frequency spectrum I, and further output a control signal 134A to adjust the power of the main laser light 101. On the other hand, the processing element 134 of the inspection unit 13 may inspect the line width of the main laser light 101 according to the full width at half maximum (FWHM) of the frequency F in the interference frequency spectrum I, and further output a control signal 134A to adjust the line width of the main laser light 101.

In summary, the photonic integrated circuit 1 and the inspection method thereof in the embodiment is using the inspection unit 13 to inspect the reference laser light 112. For example, after the reference laser light 112 is split, the frequency of one laser light is being modulated, and the modulated laser light (for example, the first sub-laser light 131A) and the unmodulated laser light (for example, the second sub-laser light 131B) are being coupled. Afterward, the interference frequency spectrum of the first coupling light 133A may be inspected to obtain the parameters, such as the light intensity P and FWHM of the frequency F, etc. Therefore, the photonic integrated circuit 1 and the inspection method thereof in the embodiment may be used to confirm whether the power and the line width of the main laser light 101 generated by the laser light source 10 is consistent with requirement.

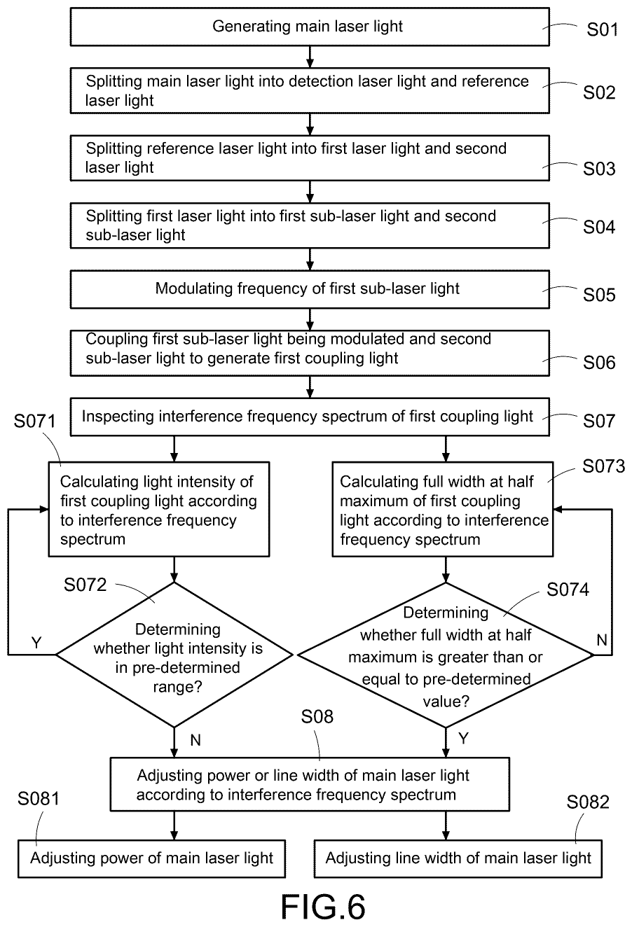

FIG. 6 is a flowchart of the inspection method of the photonic integrated circuit in the second embodiment of the disclosure. As shown in FIG. 3 and FIG. 6, the difference between the inspection method in the second embodiment and the inspection method in the first embodiment is that, in the inspection method of the second embodiment, the step S07 may further include the step S071, the step S072, the step S073, and the step S074, and the step S08 may further include the step S081 and the step S082.

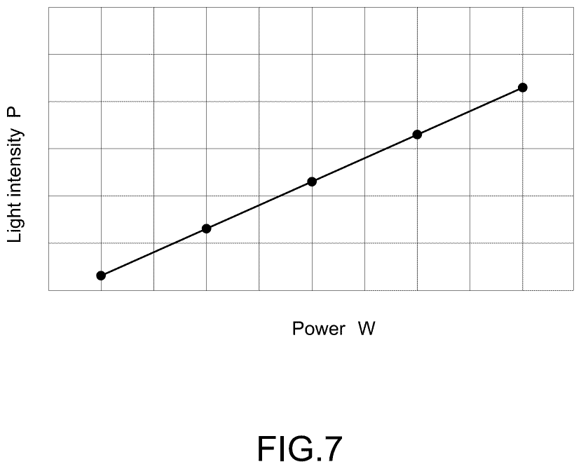

As shown in FIG. 6, the step S071 is calculating the light intensity of the first coupling light according to the interference frequency spectrum. The step S072 is determining whether light intensity is in the pre-determined range. If the light intensity is determined to be outside the pre-determined range, the step S081 is adjusting the power of the main laser light. FIG. 7 is a curve chart of the relation between the light intensity of the first coupling light and the laser power. As shown in FIG. 2, FIG. 5, FIG. 6, and FIG. 7, the distribution of the interference frequency spectrum I of the first coupling light 133A may be obtained by using fast Fourier transform to the beat frequency signal of the first coupling light 133A. Further, the processing element 134 of the inspection unit 13 may determine whether light intensity P is in the pre-determined range by calculating the light intensity P of the first coupling light 133A according to the interference frequency spectrum I. Specifically, the light intensity P in the interference frequency spectrum I is proportional to the power W of the main laser light 101 emitted from the laser light source 10 (as shown in FIG. 7). Therefore, when the processing element 134 determines that the light intensity Pis outside the pre-determined range, the processing element 134 may also determine that the power of the main laser light is outside the pre-determined range. Further, the processing element 134 may output the control signal 134A to adjust the power of the main laser light 101. It is worth mentioning that, in the embodiment, the pre-determined range is the range of the light intensity between unharmful to human eyes and unable to generate reflected signal. In other words, the upper limit to the light intensity is unharmful to human eyes, and the lower limit to the light intensity is to generate clear reflected signal.

On the other hand, if the processing element 134 determines that the light intensity is inside the pre-determined range, the process is back to the step S07, that is, re-inspecting the interference frequency spectrum of the other coupling light. In other words, the inspection unit 13 may continuously inspect the light intensity P.

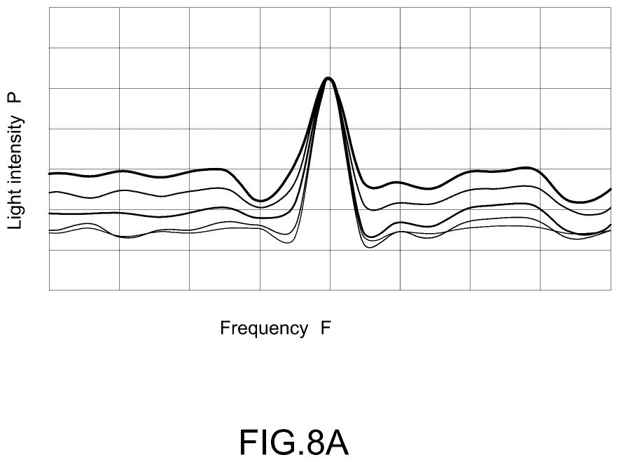

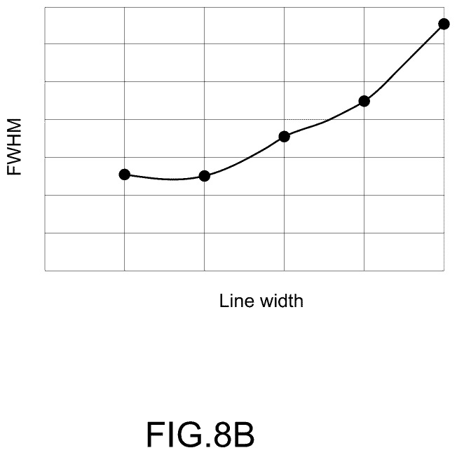

Further, referring to FIG. 2 and FIG. 6, the step S073 is calculating the FWHM of the first coupling light 133A according to the interference frequency spectrum. The step S074 is determining whether the FWHM is greater than or equal to the pre-determined value. If the FWHM is determined to be greater than or equal to the pre-determined value, the step S082 is adjusting the line width of the main laser light 101. FIG. 8A is a curve chart of the relation between the light intensity of the first coupling light and the frequency. FIG. 8B is a curve chart of the relation between the FWHM of the first coupling light and the line width of the laser light. As shown in FIG. 2, FIG. 5, FIG. 6, FIG. 8A, and FIG. 8B, the processing element 134 of the inspection unit 13 may calculate the FWHM of the first coupling light 133A according the interference frequency spectrum I, and determine whether the FWHM is greater than or equal to the pre-determined value. Specifically, the FWHM of the frequency F in the interference frequency spectrum I is proportional to the line width of the main laser light 101 emitted from the laser light source 10 (as shown in FIG. 8B). In other words, when the line width of the main laser light 101 (as shown in FIG. 1) is getting wider, the FWHM of the frequency F in the interference frequency spectrum I is getting wider (that is, the direction from left to right of the curve in FIG. 8B). Therefore, when the processing element 134 determines that the FWHM of the frequency F in the interference frequency spectrum I is greater than or equal to the pre-determined value, the processing element 134 may also determine that the line width of the main laser light 101 is greater than or equal to the pre-determined value. Further, the processing element 134 may output the control signal 134A to adjust the line width of the main laser light 101. It should be noted that the peak in the FIG. 8A is the modulated frequency of the first sub-laser light 131A (for example, the frequency of the RF signal received by the modulating element 132).

It is worth mentioning that the pre-determined value of the FWHM is not limited, different settings may be used based on different requirements. In some embodiments, the FWHM may be, for example, greater than or equal to 0.014 MHz and less than or equal to 0.018 MHz. Similarly, the pre-determined value of the line width is not limited, in some embodiments, the line width may be greater than or equal to 1 kHz and less than or equal to 100 kHz.

On the other hand, if the processing element 134 determines that the FWHM of the frequency F in the interference frequency spectrum I is less than the pre-determined value, the process is back to the step S07, that is, re-inspecting the interference frequency spectrum of the other coupling light. In other words, the inspection unit 13 may continuously inspect the FWHM of the frequency F in the interference frequency spectrum I.

It should be noted that the step S071, the step S072, and the step S081 may be performed simultaneously with the step S073, the step S074, and the step S082, or the step S071, the step S072, and the step S081 are performed in advance and then the step S073, the step S074, and the step S082 are performed, or the step S073, the step S074, and the step S082 are performed in advance and then the step S071, the step S072, and the step S081 are performed.

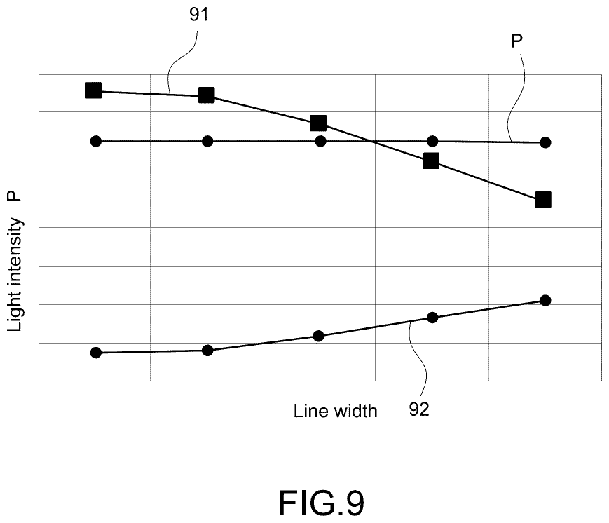

FIG. 9 is a curve chart of the relation between the noise level of the first coupling light and the line width of the laser light. By measurement, the noise level of the first sub-laser light is also proportional to the line width of the main laser light. In other words, as shown in FIG. 9, the signal noise ratio (SNR) 91 is inversely proportional to the line width 92 of the main laser light. That is, when the SNR 91 is getting smaller, the noise level is getting larger, and the line width 92 of the main laser light is getting larger. Therefore, in some embodiments, apart from using the FWHM of the frequency for inspection, the noise level of the main laser light may also be inspected for using to inspect and adjust the line width of the main laser light.

In summary, the inspection method of the photonic integrated circuit in the embodiment is using the characteristic of the light intensity being proportional to the power to determine whether the power of the laser light source is consistent with the required value may be determined by determining whether the light intensity is in the pre-determined range, and the power of the laser light source may be adjusted accordingly. Similarly, the FWHM is proportional to the line width, thus whether the line width of the laser light source is consistent with the required value may be determined by determining whether the FWHM is greater than or equal to the pre-determined value, and the line width of the laser light source may be adjusted accordingly. Therefore, the inspection method of the photonic integrated circuit in the embodiment may be used to confirm whether the power and the line width of the main laser light generated by the laser light source is consistent with requirement.

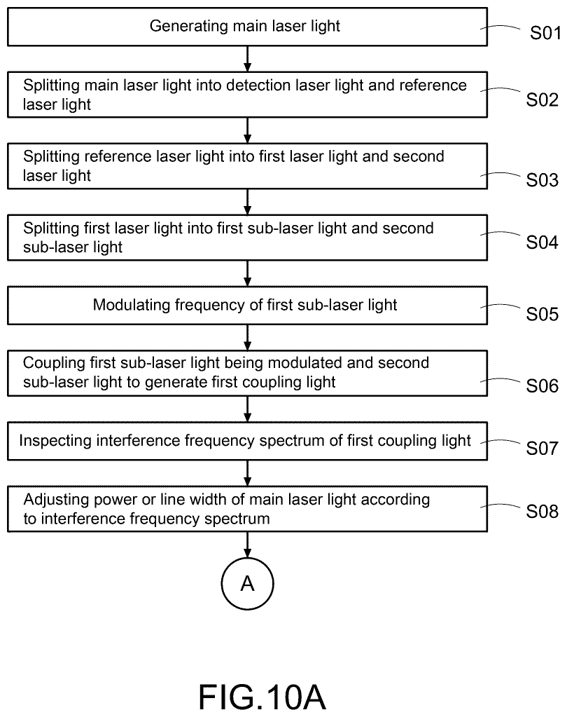

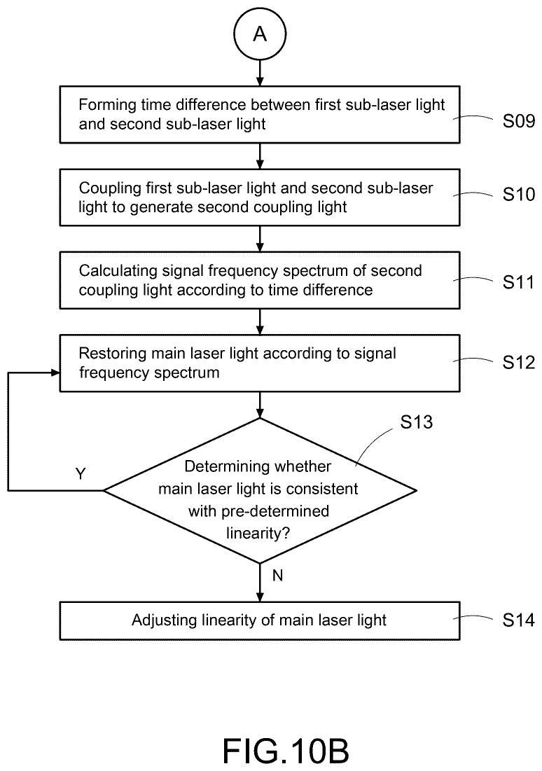

FIG. 10A and FIG. 10B are a flowchart of the inspection method of the photonic integrated circuit in the third embodiment of the disclosure. As shown in FIG. 3, FIG. 10A, and FIG. 10B, the difference between the inspection method in the third embodiment and the inspection method in the first embodiment is that the inspection method of the third embodiment further includes the step S09 to the step S14. The step S09 is forming the time difference between the first sub-laser light and the second sub-laser light. The step S10 is coupling the first sub-laser light and the second sub-laser light to generate the second coupling light. The step S11 is calculating the signal frequency spectrum of the second coupling light according to the time difference. The step S12 is restoring the main laser light according to the signal frequency spectrum. The step S13 is determining whether the main laser light is consistent with the pre-determined linearity. The step S14 is adjusting the linearity of the main laser light. It is worth mentioning that, in the embodiment, the step S09 to the step S14 are performed after the step S01 to the step S08 as an example, here is not intended to be limiting. Further, in the step S09 to the step S14, the frequency of the first sub-laser light is not modulated.

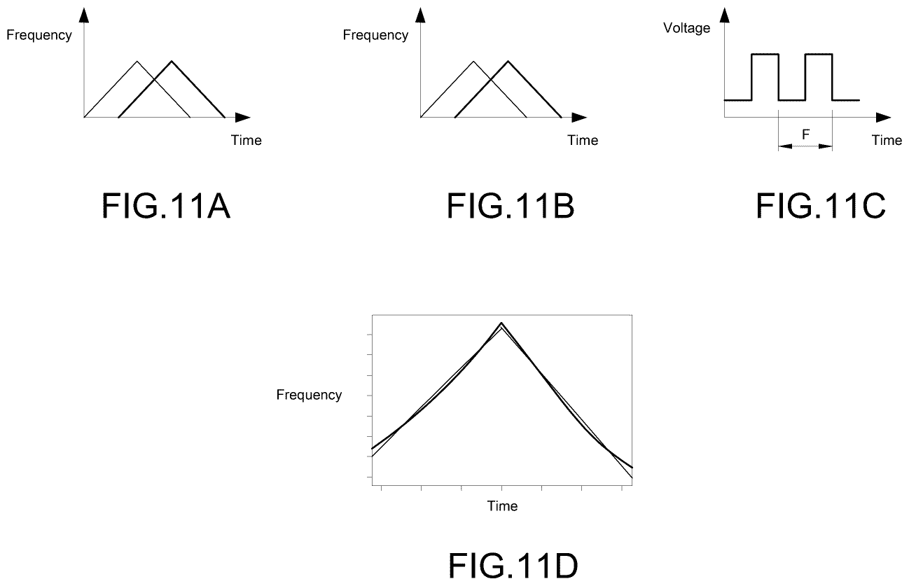

Referring to FIG. 2, FIG. 10A, and FIG. 10B, in the step S09, the time difference is formed between the first sub-laser light 131A and the second sub-laser light 131B. For example, the inspection unit 13 may further a delay element 137. The delay element 137 is used to form an optical path difference between the first sub-laser light 131A and the second sub-laser light 131B to make the first sub-laser light 131A and the second sub-laser light 131B have time difference entering the coupling element 133. FIG. 11A is a schematic diagram of the first sub-laser light and the second sub-laser light before the time difference is formed. FIG. 11B is a schematic diagram of the first sub-laser light and the second sub-laser light after the time difference is formed. As shown in FIG. 11A, before the time difference is formed, the first sub-laser light 131A and the second sub-laser light 131B are the same signal overlapped with each other. As shown in FIG. 11B, after the time difference is formed, the first sub-laser light 131A and the second sub-laser light 131B are distanced with a time difference.

Further, Referring to FIG. 2, FIG. 10A, and FIG. 10B, in the step S10, the coupling element 133 couples the first sub-laser light 131A and the second sub-laser light 131B to generate the second coupling light 133B. In the step S11, the processing element 134 calculates the signal frequency spectrum of the second coupling light 133B according to the time difference. FIG. 11C is a schematic diagram of voltage-time of the second coupling light in the embodiment. As shown in FIG. 2, FIG. 10A, FIG. 10B, and FIG. 11C, the coupling element 133 couples the first sub-laser light 131A and the second sub-laser light 131B to generate the second coupling light 133B. The second coupling light 133B is, for example, the beat frequency signal, and the frequency of the second coupling light 133B is related to the time difference between the first sub-laser light 131A and the second sub-laser light 131B.

As shown in FIG. 1, FIG. 2, FIG. 10A, and FIG. 10B, in the step S12, the processing element 134 restores the main laser light 101 according to the signal frequency spectrum. In the step S13, the processing element 134 determines whether the main laser light 101 is consistent with the pre-determined linearity. If the processing element 134 determines that the main laser light 101 is non-consistent with the pre-determined linearity, in the step S14, the processing element 134 adjust the linearity of the main laser light 101. FIG. 11D is a schematic diagram of the main laser light which is restored according to the signal frequency spectrum. Specifically, as shown in FIG. 2, FIG. 10A, FIG. 10B, FIG. 11C, and FIG. 11D, after the processing element 134 obtains the signal frequency spectrum (as FIG. 11C) of the second coupling light 133B, the relation between the signal and the time difference may be obtained by:

fb=f (t)−f (t−τₘ), wherein τₘ is the time difference between two optical signal.

When τₘ is far less than one period of FMCW (that is, the main laser light), the equation may be simplified as below through Taylor series.

fb=f′(t)τₘ

Next, using Hilbert transform to extract the phase of the signal as:

Φb=2πf(t)τₘ

After conversion, the signal of the original main laser light may be restored as:

f(t)=Φb/2πτm

As a result, the waveform of the restored main laser light 101 as shown in FIG. 11D may be obtained. Further, the processing element 134 may further output control signal 134A to adjust the linearity of the main laser light 101 through determining whether the main laser light 101 is consistent with the pre-determined linearity. It is worth mentioning that the pre-determined linearity is not limited, different settings may be used based on different requirements. In some embodiments, the pre-determined linearity may be, for example, greater than or equal to 95% and less than or equal to 100%.

On the other hand, if the processing element 134 determines that the restored main laser light 101 is consistent with the pre-determined linearity, the process is back to the step S12, that is, re-inspecting the waveform of the restored main laser light from the signal frequency spectrum of the other coupling light. In other words, the inspection unit 13 may continuously inspect the linearity of the main laser light.

In summary, in the inspection method of the photonic integrated circuit of the embodiment, after the reference laser light is split, the laser light may not be modulated, and the time difference may be formed between two laser light by using optical path difference. The signal frequency spectrum of the coupling light is calculated based on the time difference. As a result, whether the linearity of the laser light source is consistent with the required value may be determined by restoring the signal frequency spectrum to the waveform of the main laser light. Therefore, apart from confirming whether the power and the line width of the main laser light generated by the laser light source is consistent with requirement, the inspection method of the photonic integrated circuit of the embodiment may also be used to confirm whether the linearity of the main laser light generated by the laser light source is consistent with requirement.

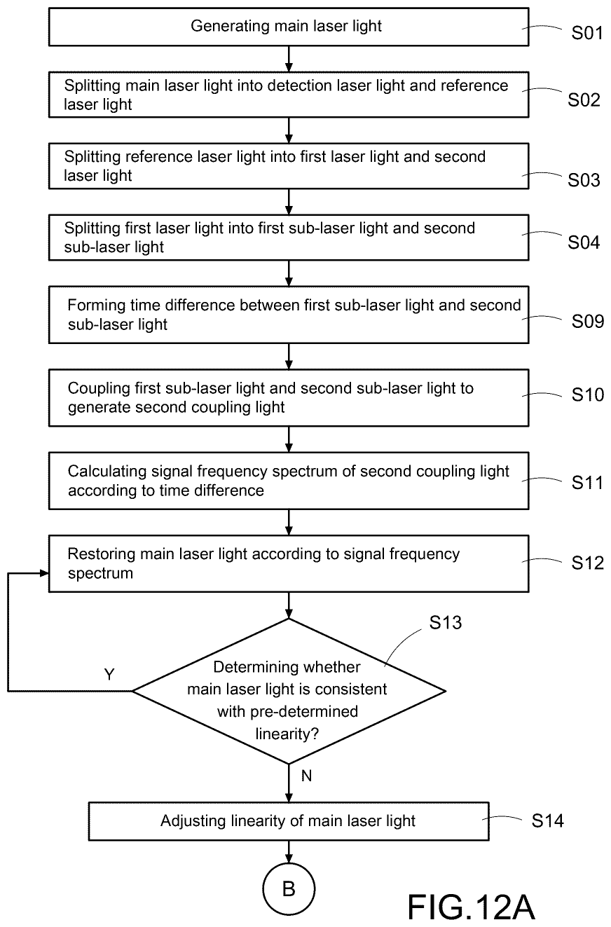

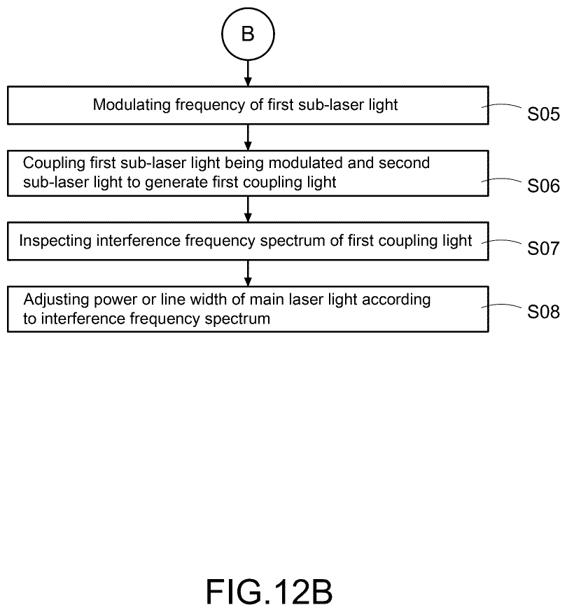

FIG. 12A and FIG. 12B are a flowchart of the inspection method of the photonic integrated circuit in the fourth embodiment of the disclosure. As shown in FIG. 10A, FIG. 10B, FIG. 12A, and FIG. 12B, the difference between the inspection method in the fourth embodiment and the inspection method in the third embodiment is that the step S09 to the step S14 is performed after the step S04. After the step S09 to the step S14 is performed, the step S05 to the step S08 is performed. In other words, the inspection method of the embodiment may be used to inspect the linearity of the main laser light in advance, and then inspect the power and the line width of the main laser light. It should be noted that, in the step S09 to the step 14, the frequency of the first sub-laser light is not modulated either.

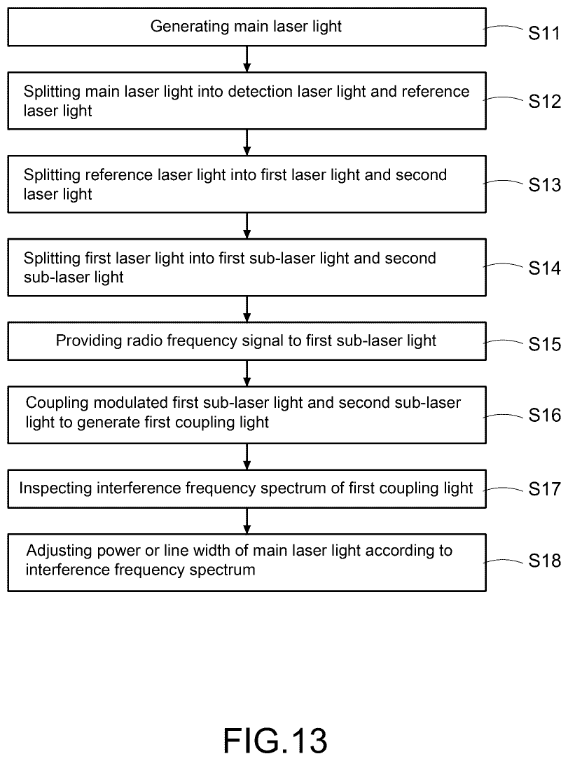

FIG. 13 is a flowchart of the inspection method of the photonic integrated circuit in the fifth embodiment of the disclosure. As shown in FIG. 13 and FIG. 3, the difference between the inspection method in the fifth embodiment and the inspection method in the first embodiment is that, in the step S15, the RF signal is provided to the first sub-laser light. The other steps, such as the step S11 to the step S14 and the step 16 to the step S18, are the same with the step S01 to the step S04 and the step S06 to the step S08 in the first embodiment, here is omitted for brevity.

In the step S15, the RF signal is provided to the first sub-laser light. As a result, the frequency of the first sub-laser light may be modulated. The same with the first embodiment, the second sub-laser light and the modulated first sub-laser light are coupled to generate the first coupling light. The first coupling light is, for example, a beat frequency signal. The frequency of the first coupling light is related to the frequency of the modulated first sub-laser light. Therefore, as described in the first embodiment, the power or the line width of the main laser may be adjusted by inspecting the interference frequency spectrum.

It is worth mentioning that the inspection method of the fifth embodiment may also be applied to the embodiments in FIG. 6, FIG. 10A, FIG. 10B, FIG. 12A, and FIG. 12B, here is omitted for brevity.

In summary, the photonic integrated circuit and the inspection method thereof in the disclosure is using the inspection unit to inspect the reference laser light. For example, after the reference laser light is split, the frequency of one laser light is being modulated, and the modulated laser light (for example, the first sub-laser light) and the unmodulated laser light (for example, the second sub-laser light) are being coupled. Afterward, the interference frequency spectrum of the coupling light may be inspected to obtain the parameters, such as the light intensity and full width at half maximum (FWHM), etc. The light intensity is proportional to the power, thus whether the power of the laser light source is consistent with the required value may be determined by determining whether the light intensity is in the pre-determined range, and the power of the laser light source may be adjusted accordingly. Similarly, the FWHM is proportional to the line width, thus whether the line width of the laser light source is consistent with the required value may be determined by determining whether the FWHM is greater than or equal to the pre-determined value, and the line width of the laser light source may be adjusted accordingly. Further, after the reference laser light is split, the laser light may not be modulated, and the time difference may be formed between two laser light by using optical path difference. The signal frequency spectrum of the coupling light is calculated based on the time difference. As a result, whether the linearity of the laser light source is consistent with the required value may be determined by restoring the signal frequency spectrum to the waveform of the main laser light. Therefore, the photonic integrated circuit and the inspection method thereof in the disclosure may be used to confirm whether the power, line width, and linearity of the main laser light generated by the laser light source is consistent with requirement.

While this disclosure has been described by means of specific embodiments, numerous modifications and variations may be made thereto by those skilled in the art without departing from the scope and spirit of this disclosure set forth in the claims.

What is claimed is:

1. An inspection method of a photonic integrated circuit, the inspection method comprising steps of:
generating a main laser light;
splitting the main laser light into a detection laser light and a reference laser light;
splitting the reference laser light into a first laser light and a second laser light;
splitting the first laser light into a first sub-laser light and a second sub-laser light;
modulating a frequency of the first sub-laser light;
coupling the first sub-laser light being modulated and the second sub-laser light to generate a first coupling light;
inspecting an interference frequency spectrum of the first coupling light; and
adjusting a power or a line width of the main laser light according to the interference frequency spectrum.

2. The inspection method of claim 1, wherein the inspecting of the interference frequency spectrum of the first coupling light further comprises steps of:
calculating a light intensity of the first coupling light according to the interference frequency spectrum; and
determining whether the light intensity is in a pre-determined range.

3. The inspection method of claim 2, wherein the adjusting of the power or the line width of the main laser light according to the interference frequency spectrum further comprises a step of:
adjusting the power of the main laser light, if the light intensity is determined to be outside the pre-determined range.

4. The inspection method of claim 1, wherein the inspecting of the interference frequency spectrum of the first coupling light further comprises steps of:
calculating a full width at half maximum (FWHM) of the first coupling light according to the interference frequency spectrum; and
determining whether the FWHM is greater than or equal to a pre-determined value.

5. The inspection method of claim 4, wherein the adjusting of the power or the line width of the main laser light according to the interference frequency spectrum further comprises:
adjusting the line width of the main laser light, if the FWHM is determined to be greater than or equal to the pre-determined value.

6. The inspection method of claim 1, further comprising steps of:
forming a time difference between the first sub-laser light and the second sub-laser light;
coupling the first sub-laser light and the second sub-laser light to generate a second coupling light;
calculating a signal frequency spectrum of the second coupling light according to the time difference;
restoring the main laser light according to the signal frequency spectrum; and
determining whether the main laser light is consistent with a pre-determined linearity.

7. The inspection method of claim 6, wherein the determining of whether the main laser light is consistent with a pre-determined linearity further comprises a step of:
adjusting a linearity of the main laser light, if the main laser light is determined to be non-consistent with the pre-determined linearity.

8. An inspection method of a photonic integrated circuit, the inspection method comprising steps of:
generating a main laser light;
splitting the main laser light into a detection laser light and a reference laser light;
splitting the reference laser light into a first laser light and a second laser light;
splitting the first laser light into a first sub-laser light and a second sub-laser light;
providing a radio frequency signal to the first sub-laser light;
coupling the first sub-laser light being modulated and the second sub-laser light to generate a first coupling light;
inspecting an interference frequency spectrum of the first coupling light; and
adjusting a power or a line width of the main laser light according to the interference frequency spectrum.

9. The inspection method of claim 8, wherein the inspecting of the interference frequency spectrum of the first coupling light further comprises steps of:
calculating a light intensity of the first coupling light according to the interference frequency spectrum; and
determining whether the light intensity is in a pre-determined range.

10. The inspection method of claim 9, wherein the adjusting of the power or the line width of the main laser light according to the interference frequency spectrum further comprises a step of:
adjusting the power of the main laser light, if the light intensity is determined to be outside the pre-determined range.

11. The inspection method of claim 8, wherein the inspecting of the interference frequency spectrum of the first coupling light further comprises steps of:
calculating a full width at half maximum (FWHM) of the first coupling light according to the interference frequency spectrum; and
determining whether the FWHM is greater than or equal to a pre-determined value.

12. The inspection method of claim 11, wherein the adjusting of the power or the line width of the main laser light according to the interference frequency spectrum further comprises a step of:
adjusting the line width of the main laser light, if the FWHM is determined to be greater than or equal to the pre-determined value.

13. The inspection method of claim 8, further comprising steps of:
forming a time difference between the first sub-laser light and the second sub-laser light;
coupling the first sub-laser light and the second sub-laser light to generate a second coupling light;
calculating a signal frequency spectrum of the second coupling light according to the time difference;
restoring the main laser light according to the signal frequency spectrum; and
determining whether the main laser light is consistent with a pre-determined linearity.

14. The inspection method of claim 13, wherein the determining of whether the main laser light is consistent with a pre-determined linearity further comprises a step of:
adjusting a linearity of the main laser light, if the main laser light is determined to be non-consistent with the pre-determined linearity.

15. A photonic integrated circuit, comprising steps of:
a laser light source, configured to generate a main laser light;
a first splitter, configured to receive the main laser light, and to split the main laser light into a detection laser light and a reference laser light;
a second splitter, configured to receive the reference laser light, and to split the reference laser light into a first laser light and a second laser light; and
an inspection unit, configured to receive the first laser light, and comprising:
a third splitter, configured to receive the first laser light, and to split the first laser light into a first sub-laser light and a second sub-laser light;
a modulating element, configured to receive the first sub-laser light, and to modulate a frequency of the first sub-laser light;
a light-coupling element, configured to receive and couple the second sub-laser light and the first sub-laser light being modulated, and to generate a first coupling light; and
a processing element, configured to inspect an interference frequency spectrum of the first coupling light,
wherein the inspection unit is configured to adjust a power or a line width of the main laser light according to the interference frequency spectrum.

16. The photonic integrated circuit of claim 15, wherein the processing element is configured to calculate a light intensity of the first coupling light according to the interference frequency spectrum and determine whether the light intensity is in a pre-determined range, and
the processing element is configured to adjust the power of the main laser light, if the light intensity is determined to be outside the pre-determined range.

17. The photonic integrated circuit of claim 15, wherein the processing element is configured to calculate a full width at half maximum (FWHM) of the first coupling light according to the interference frequency spectrum and determine whether the FWHM is greater than or equal to a pre-determined value, and
the processing element is configured to adjust the line width of the main laser light, if the FWHM is determined to be greater than or equal to the pre-determined value.

18. The photonic integrated circuit of claim 15, wherein the modulating element is configured to receive a radio frequency signal, and to modulate the frequency of the first sub-laser light according to the radio frequency signal.

19. The photonic integrated circuit of claim 15, wherein the inspection unit further comprises a delay element, configured to receive the first sub-laser light and form a time difference between the first sub-laser light and the second sub-laser light; and
the light-coupling element is configured to couple the first sub-laser light and the second sub-laser light to generate a second coupling light.

20. The photonic integrated circuit of claim 19, wherein the processing element is configured to calculate a signal frequency spectrum of the second coupling light according to the time difference and restore the main laser light according to the signal frequency spectrum, and
the processing element is configured to adjust a linearity of the main laser light, if the main laser light is determined to be non-consistent with a pre-determined linearity.
